(19) United States
(12) Patent Application Publication
(10) Pub. No.: US 2005/0022729 A1
(43) Pub. Date: Feb. 3, 2005

(54) Cleaning and coating apparatus, and a method for a moving surface

(75) Inventors: Pekka Kiiski, Tampere (FI); Jussi Alenius, Julkujarvi (FI); Antti Laakso, Vuorentausta (FI); Tero Vartiainen, Ylojarvi (FI)

Correspondence Address: VENABLE, BAETJER, HOWARD AND CIVILETTI, LLP, P.O. BOX 34385, WASHINGTON, DC, 20043-9998, US

(73) Assignee: Fastems Oy Ab, TAMPERE (FI)

(21) Appl. No.: 10/895,306

(22) Filed: Jul. 21, 2004

(30) Foreign Application Priority Data
Aug. 1, 2003 (FI) 20031124

(51) Int. Cl. B05C 1/00; B05C 1/06; B05D 3/00

(52) U.S. Cl. 118/203; 427/352

(57) ABSTRACT

A cleaning and coating apparatus for on-line cleaning of a moving surface, which comprises a cleaning unit, which is arranged for the mechanical cleaning of a moving surface, and a frame structure, to which said cleaning unit is attached and arranged to move back and forth over the moving surface. The apparatus also comprises a coating unit, which is arranged to apply the coating on a moving surface and to process it in a desired manner, for example, for attaching, in which case said coating unit is also coupled to said frame structure and arranged to move back and forth over a moving surface. The cleaning apparatus comprises a cleaning unit, which is arranged for the mechanical cleaning of a moving surface, and a frame structure, which the cleaning unit in question is attached to and arranged to move back and forth over the moving surface. In addition, the apparatus is arranged to automatically and according to the method replace the cleaning tool in use with a new cleaning tool.

### CROSS-REFERENCE TO RELATED APPLICATIONS

This application claims priority under 35 USC §119 to Finnish Patent Application No. 20031124 filed on Aug. 1, 2003.

### FIELD OF THE INVENTION

The invention relates to a cleaning and coating apparatus for on-line cleaning of a moving surface. The invention also relates to a cleaning apparatus for on-line cleaning of a moving surface. In addition, the invention relates to a method in the on-line cleaning of a moving surface.

### BACKGROUND OF THE INVENTION

In order to clean, for example, the rotating rolls of a paper machine, different brushes are used in a known manner, which brush over the entire width of the roll or which move in the direction of the roll and perform cleaning. For example, publication DE 10121679 A1 presents a so-called traversing cleaner device, which sprays washing agent onto a rotating roll and performs cleaning, for example by brushing. Other cleaning systems, which also operate during the use of the roll, i.e. on-line, and in which case the rolls do not need to be removed for cleaning, are presented, inter alia, in publication WO 02/064887 A1, publication WO 01/96659 A1, publication U.S. Pat. No. 4,953,252, and publication WO 02/20901 A1, which also comprises a system for detecting fouling or impurities of the roll and for starting cleaning on the basis of the detections, as well as in the calender system of publication WO 01/63048 A1. For cleaning a moving felt or wire, there in turn exists an apparatus according to U.S. Pat. No. 5,783,044. In addition, a traversing sponge is also available for cleaning, such as in publication WO 02/055305.

To the on-line grinding of the roll surface is in turn connected publication EP 0676501 B1, by means of which the coarseness of the roll surface can be controlled. A cleaning system is described in the publication DE 19961666 A1, which utilizes a so-called suction box and lip seal.

Rolls, wires and felts can also be coated separately, and publications WO 99/35332 and EP 0487477 B1 present two coating apparatuses.

### SUMMARY OF THE INVENTION

The purpose of the invention is to complement the systems according to prior art, whose properties from the point of view on-line operation are insufficient or the functions limited. Placing known on-line systems, for example, in a calender system or a paper machine, for processing either a rotating roll or other moving surface, is either impossible or requires special arrangements.

An advantage of the invention is the integration of different functions in the same apparatus, in which case its placement becomes easier. By means of the cleaning apparatus, different types of cleanings, if necessary, are possible, in which case it can be performed in the desired manner, when necessary, or in a manner according to possibilities during production, in connection with web breaks, or during washing shutdowns. In order for the coating to succeed, the surface must be clean enough or the surface roughness properties suitable. The thorough enough pre-processing of the surface is easily arranged with the device according to the invention, because the cleaning unit is placed in the same apparatus with the coating system.

By placing the coating system in the same apparatus, the cleaning apparatus can be utilized in connection with coating, by means of which apparatus different types of cleanings are possible. There is less maintenance of the apparatus, because, inter alia, the cleaning apparatus is able to replace a used and worn brush with a new one. The replacement system is utilized also in the storage of different types of brushes or cleaning means, in which case different cleaning methods have been made possible. In addition to the brush, the purpose is also to use other rotating tools suitable for cleaning. When using, for example, a system, which detects the impurities of a surface, it is possible with the apparatus of the invention to select the most suitable brush type for use each time from the magazine, and the cleaning manner, and therefore the usage possibilities of the system are wide.

By placing the coating system in the same structure, it is especially possible to quickly utilize different production shutdowns, which enable coating. In an embodiment of the invention, devices have been taken into use, with which it is possible to automatically serve several different cleaning and/or coating apparatuses.

### DESCRIPTION OF THE DRAWINGS

In the following, the invention will be described in more detail with reference to the appended drawings, in which

FIG. 1 shows the general principle and structure of a system according to the invention, when it is place at the roll,

FIG. 2 shows the cleaning and coating apparatus of the apparatus of FIG. 1 in more detail,

FIG. 3 shows a front view of the system of FIG. 1,

FIG. 4 shows a side view of the system of FIG. 1, and

FIG. 5 shows an apparatus that serves several different systems.

### DETAILED DESCRIPTION OF THE INVENTION

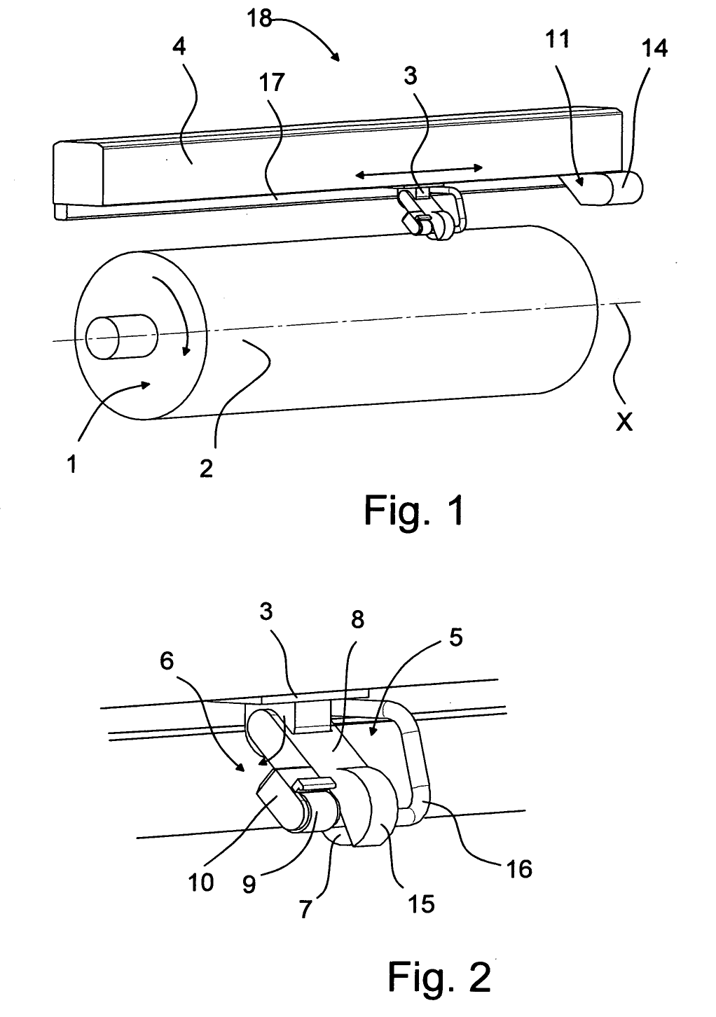

The system 18 according to FIG. 1 is intended for maintaining the cleanness of moving surfaces, in which case the moving surface is cleaned mechanically. The cleaned surface is also coated to repel impurities, in which case the surface remains clean, and if necessary, it is easily cleaned. The surface in question can especially be a rotating roll, a moving belt or any other moving surface, to which cleaning and coating procedures are desired to be aimed at. The surface is preferably such that rotates back to the apparatus 18 so that its entire surface can be processed during several rounds, because the apparatus 18 processes only a part of the entire width of the surface at a time. In FIG. 1 the surface in question is the cylindrical surface 2 of the roll 1.

According to FIG. 1, the cleaning and coating units processing the surface are placed in a back and forth moving, i.e., a traversing carrier 3. The carrier 3 moves substantially in the direction of the length and rotating axis X of the roll 1 from one end of the roll 1 to the other, by preferably covering the entire length of the roll 1 while the roll 1 rotates. The movement of the carrier is transverse in relation to the rotating direction of the roll 1 or the direction of movement of the surface being cleaned. The roll 1 is arranged as rotatable in a manner known as such, which depends on the placement of the roll 1. The carrier 3 moves linearly along a straight beam structure 4, which also extends substantially in the direction of the X-axis and extends enough over the roll 1 and/or the other surface travelling via the roll 1, in which case it is preferably placed at a constant distance from the surface 2. The beam 4 is supported at its ends by, for example, the floor or other fixed structures in a desired manner. The entire beam 4 can, in addition, be arranged to move towards the roll 1 and away from it, but preferably it is installed in a fixed manner to the desired location in a paper machine, a conveyor system, or other processing system. The beam structure 4 is structured firm enough, but, however, so small in its cross-section that its space requirement is as small as possible in order to facilitate its placement.

The apparatus 18 comprises a mechanical cleaning unit 5, which is placed in the carrier 3. The carrier 3 and a brushing unit 5 placed in it, as well as a coating unit 6 are presented more in detail in FIG. 2. In this embodiment the cleaning unit 5 comprises a changeable brush 7, which rotates around its central axis, which is parallel to the traversing movement. Other cleaning tools also come into question. The brush 7 is rotated and pressed against the surface 2. The brush 7 is placed, for example, in a rocking arm 8, through which the brush 7 is pressed against the surface 2, in which case it is possible to use mechanisms known as such, or regulating units, such as a pneumatic cylinder, which is coupled between the carrier 3 and the arm 8. Wear of the cleaning means 7 or the cleaning result created on the surface 2 to be cleaned is detected by means of sensors, for example, optical sensors. If necessary, the tool 7 is transferred automatically towards the surface 2 to be cleaned in such a manner that, for example, the diameter change of a round tool is compensated. Towards the surface, the transfer is made by turning the arm 8 or by adjusting the length of the arm 8. The rotation of the brush 7 is implemented, for example, by means of an electric motor or a pneumatic motor, by using, for example, belt transmission, if necessary. The rotating rate and pressing strength can be selected by programming, in which case a separate control unit controls different actuators, which control unit may be located also in the carrier 3 or in the vicinity of the apparatus. If necessary, the control unit is in turn in connection with the control computer of the processing system, by means of which the different functions can be started at a desired moment or functional parameters can be set. In connection with actuators and the rest of the system there are, in addition, required sensor, which monitor the operation and give indications of it to the control unit.

The structure and placement of the arm 8 is such that, for example, when a web break of a paper web takes place, or a sudden force is directed to the cleaning means 7 or the arm 8, the structure parts close to the surface to be cleaned move further away from the surface. Thanks to the movement, no parts of the apparatus are damaged.

A coating unit 6 is also placed in the carrier 3, by means of which the desired coating chemical is applied on the surface 2. The coating chemical can be any chemical, which is applied on the surface at regular intervals, or when necessary, and is attached to the surface being processed by means of a suitable method, for example, by means of heat or light. In the embodiment of FIG. 2, a moving belt 9 is used for applying, but in connection with this it is also possible to apply application methods known as such, such as a rotating roll or some wiping material, to which the coating chemical is fed and from where it transfers onto the surface 2 to be coated, or a dragging spattle or a spraying nozzle. The chemical is lead to the unit 6 by means of, for example, channelling, which is placed protected by the beam structure 4. Electricity input or input of compressed air can also be placed protected by the beam structure 4 or on the surface, which makes the movement of the carrier 3 possible. The chemical is input, for example, by means of a tank or pump system, which can be known as such by its components. A chemical applied on the surface is attached by means of a heating device, a light instrument, or some other attachment method. The required devices or tools are placed, for example, protected inside the casing 10.

In the embodiment of FIG. 2, the coating unit 6 is placed in the same rocking arm 8 with the brush 7, but the carrier can also be provided with a separate rocking arm, to which the unit 6 is placed. The unit 6 can be placed in a separate carrier as well, which operates similarly to the carrier 3 of FIG. 2, but moves, for example, along the same guides, for example on the lower surface of the structure 4 according to FIG. 1. It is possible to provide the front and back surfaces of the structure with a separate guide as well, where either the coating unit 6 or the cleaning unit 5 move, but the structure naturally becomes more extensive. Similarly, the devices by means of which the coating chemical is attached, can be placed in a separate carrier, which moves either along the guides of the carrier 3 or other guides, for example, on the upper surface of the structure 4. If several carriers move in the same guide, the structure 4 is to be arranged long enough in order for the carrier and the apparatus attached to it to reach the entire surface 2.

A tool magazine 11 is placed in the end of the movement area of the cleaning unit 5, in which magazine the arm 8 attached to the carrier 3 goes to select, by programming, a spare tool or other type of a tool, in this case a similar brush 13 to replace the worn one, or a different type of a brush 12 or cleaning tool for different type of cleaning, depending on the desired cleaning manner and method. By replacing the worn brush automatically with a new one, the automation periods without maintenance can be extended. A special advantage is reached in that with the replacement system it is possible to use brushes cleaning with different efficiencies, depending on, inter alia, whether the cleaning is a gentle maintenance cleaning that is possibly repeated often or is enough for normal cleaning, or if it is a basic cleaning requiring more efficient brushing that is repeated infrequently or is necessary as a result of heavy fouling. Basic cleaning is required, inter alia, before coating.

In the arm 8 there is a mechanism gripping to, for example, the centre of a round brush, which can be opened and locked into place, and via which the brush is rotated. The mechanism in question, for example, fits between the brushes of the magazine 11 and can either release the desired brush to a holder or brush clamp in the magazine, or take a new brush from it to replace the released one. There can also be a controlled mechanism in the holder, which locks and releases the brush. In the embodiment of FIGS. 1 and 2, the brushes and cleaning means are placed protected under the casing 14. The magazine 11 can be placed either in the same carrier 3 or a separate carrier, by means of which it can be brought to the carrier 3. When the magazine 11 is placed in the end of the structure 4, its brushes are easy to replace manually, or the entire magazine can be changed at once, including a different type of a cleaning tool selection. If necessary, the control must be told which position each cleaning tool is in and what its type is. A holder or a clamp can function as a magazine, where one or more tools are stored short-term.

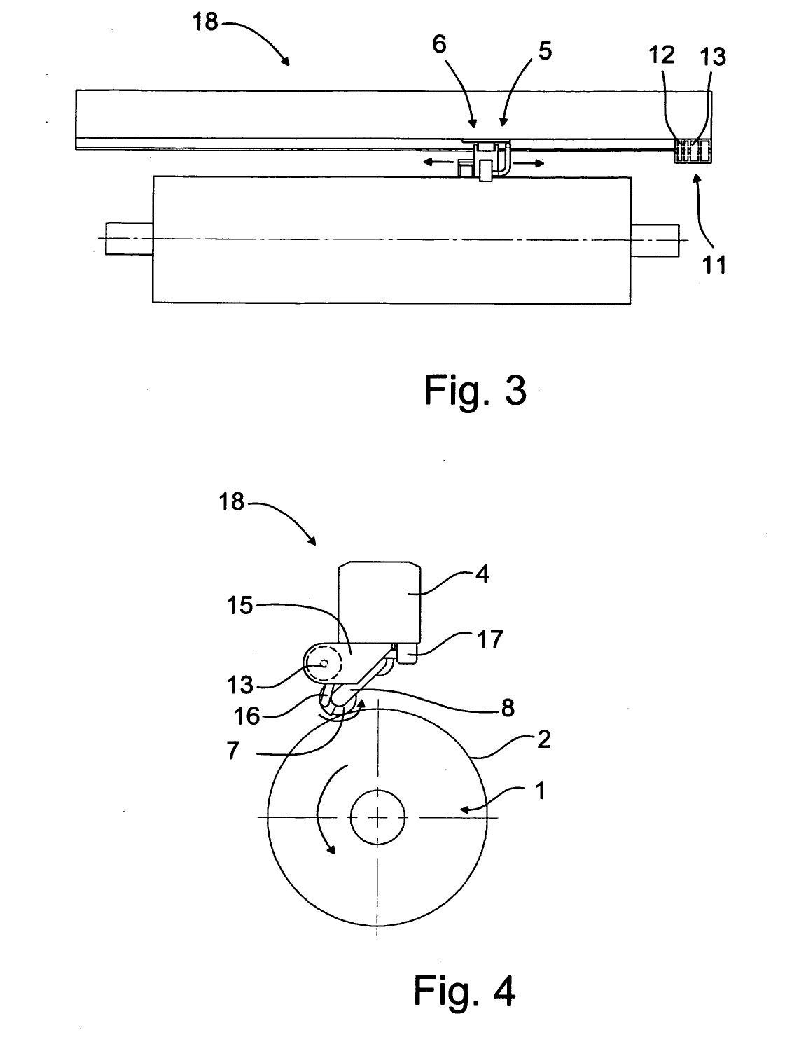

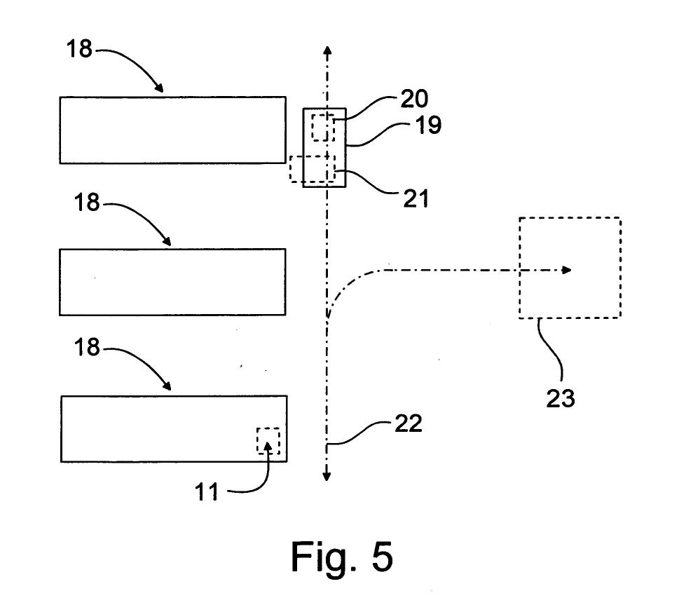

According to an embodiment of the invention and FIG. 5, the magazine or a similar cleaning tool storage 20 is placed in an automatically moving carriage 19, which belongs to the apparatus and which can move to the cleaning unit. Thus, it can be arranged that the carriage 19 serves several different apparatuses 18, of which a magazine 11 is missing or in whose magazine 11 the apparatus 21 of the carriage 19 places tools. This then refers especially to calender systems, in which case the carriage 19 moves vertically and in which case the maintenance of the upper apparatuses 18 becomes easier. If necessary, it can even be arranged that the carriage 19 changes the entire magazine 11 into a new one. The apparatus 21 does not necessarily have to be, for example, a manipulator, a robot or other automatically functioning change device, which assembles the tool, or some other part or an assembly of parts, directly in the cleaning unit 5. If one or more magazines 20 of the carriage 19 can be positioned into a position according to FIG. 3 and the magazine 11, the cleaning unit 5 can change a new tool itself.

The carriage 19 travels preferably along a pre-determined route 22 under control, in which case an individual maintenance area 23 can be determined for it, where entire magazines or individual tools that the carriage 19 carries can be stored. The maintenance and condition monitoring of the tools can be arranged in a centralized manner, for example, on the maintenance area 23, if the magazines or tools are placed separately from the apparatus 18, for example in the carriage 19.

There is a half open casing 15 around the rotating brush 7, from where leaves a suction channel 16. The impurities brushed off and released from the surface 2 are carried along the suction line to a sanitary trap, which separates impurities from the suction air. The suction line is placed protected, for example, inside the structure 4 or on the surface in such a manner that the carrier can move. According to the embodiment of FIG. 1, the suction channel 16 is in connection with the suction box 17, which is of the length of the structure 4 and covers the movement area of the carrier. Negative pressure is arranged inside the suction box 17, which causes suction. The end of the suction channel 16 extends inside the suction box 17 by placing into a gap that is of the length of the suction box. The gap is sealed with a lip seal, which otherwise closes the gap, but allows the end of the suction channel 16 to move in the direction of the suction box 17 (X-direction), in which case the lip seal is always open at the end of the suction channel 16.

By means of the system according to the invention it is possible to perform versatile cleaning, which is either continuous, periodical or allocated. The surface 2 can be cleaned continuously during the production process. The cleaning can also be performed at desired intervals during production, web breaks or washing shutdowns. The cleaning unit 5 can be directed to clean that part of the surface 2, where a cleaning need is detected visually, by means of the fault detection system of the manufacturing process, computer vision, or other method. The carrier 3 is therefore directed according to prior art by means of motors and, for example, belt drive, in which case the motors or the carrier 3 itself comprise the required sensoring for determining the location of the carrier 3, and therefore the control knows the position of the carrier 3 and can drive it to the desired place to perform cleaning.

The invention is not limited solely to the examples presented above, but it may vary within the scope of the appended claims. The system corresponding to the magazine 20 or the replacement system 21 for the cleaning unit 5 can be applied also in connection with the coating unit 6. Thus, for example, the carriage 19 takes care of the replacement or renewal of the coating tools 9 of one or more coating units 6, or some other part or assembly of parts, in which case, if necessary, a carrying or replaceable magazine, whose use corresponds to the magazine 11, is also used.

1. A cleaning and coating apparatus for on-line cleaning of a moving surface, comprising:
a cleaning unit, which is arranged for the mechanical cleaning of the moving surface,
a frame structure, to which said cleaning unit is attached and arranged to move back and forth over a moving surface, and
a coating unit, which is arranged to apply coating on a moving surface and to process it in the desired manner, for example for attaching,
wherein said coating unit is also coupled to said frame structure and arranged to move back and forth over the moving surface.

2. The apparatus according to claim 1, wherein it comprises a moving carrier, which is coupled to said frame structure, wherein the cleaning unit and the coating unit are coupled to said same moving carrier.

3. The apparatus according to claim 1, wherein it comprises a magazine where the at least one cleaning tool used by the cleaning unit is stored for replacement, wherein said cleaning unit is in addition arranged to automatically replace the cleaning tool in use with a new cleaning tool.

4. The apparatus according to claim 2, wherein it comprises a magazine where the at least one cleaning tool used by the cleaning unit is stored for replacement, wherein said cleaning unit is in addition arranged to automatically replace the cleaning tool in use with a new cleaning tool.

5. The apparatus according to claim 1, wherein the cleaning unit is arranged to use a rotating cleaning tool.

6. The apparatus according to claim 1, wherein the coating unit in addition comprises devices for attaching a coating applied on a moving surface.

7. The apparatus according to claim 2, wherein the coating unit in addition comprises devices for attaching a coating applied on a moving surface.

8. The apparatus according to claim 1, wherein the moving surface is the rotating roll of a paper machine or a calender system, a moving belt of a conveyor apparatus, or other surface rotating at an apparatus.

9. The apparatus according to claim 1, wherein the apparatus is in addition arranged to automatically replace the cleaning tool used by the cleaning unit, or some other part or assembly of parts, and/or the coating tool used by the coating unit, or some other part or assembly of parts.

10. The apparatus according to claim 2, wherein the apparatus is in addition arranged to automatically replace the cleaning tool used by the cleaning unit, or some other part or assembly of parts, and/or the coating tool used by the coating unit, or some other part or assembly of parts.

11. The apparatus according to claim 7, wherein the apparatus is in addition arranged to automatically replace the cleaning tool used by the cleaning unit, or some other part or assembly of parts, and/or the coating tool used by the coating unit, or some other part or assembly of parts.

12. A cleaning apparatus for on-line cleaning of a moving surface, comprising:
a cleaning unit, which is arranged for the mechanical cleaning of the moving surface, and
a frame structure, to which said cleaning unit is attached and arranged to move back and forth over a moving surface,
wherein the apparatus is also arranged to automatically replace the cleaning tool in use with a new cleaning tool.

13. The apparatus according to claim 12, wherein the cleaning unit is arranged to use a rotating cleaning tool.

14. The apparatus according to claim 12, wherein it comprises an automatically moving carriage, which serves the cleaning unit of one or more different apparatuses and to which a magazine where the at least one cleaning tool used by the cleaning unit is stored, or at least one changeable cleaning tool is placed for replacement.

15. The apparatus according to claim 14, wherein in said carriage are placed devices, which are arranged to automatically perform the replacement of said magazine or cleaning tool of a cleaning unit.

16. The apparatus according to claim 12, wherein it comprises a magazine where the at least one cleaning tool used by the cleaning unit is stored, wherein said magazine is placed separately from the moving cleaning unit, attached to said frame structure, either in a fixed position or in such a manner that it can move to the cleaning unit.

17. A method in on-line cleaning of a moving surface, the method comprising:
processing a moving surface by means of a traversing cleaning unit, which is intended for the mechanical cleaning of a moving surface,
storing at least one cleaning tool used by the cleaning unit in a replacement magazine arranged for the purpose.

18. The method according to claim 17, the method comprising:
replacing the cleaning tool used by the cleaning unit automatically with a new cleaning tool.

19. The method according to claim 17, the method comprising:
storing different types of cleaning tools in the replacement magazine, by means of which is performed various types of cleaning, for example, basic cleaning or lighter maintenance cleaning.

20. The method according to claim 18, the method comprising:
storing different types of cleaning tools in the replacement magazine, by means of which is performed various types of cleaning, for example, basic cleaning or lighter maintenance cleaning.

21. The method according to claim 17, the method comprising:
coating and processing the moving surface with the coating unit, which is placed in the same system with the cleaning unit, wherein the cleaning preceding the coating is performed by means of said cleaning unit.

22. The method according to claim 19, the method comprising:
coating and processing the moving surface with the coating unit, which is placed in the same system with the cleaning unit, wherein the cleaning preceding the coating is performed by means of said cleaning unit.
